(19) United States
(12) Patent Application Publication
(10) Pub. No.: US 2009/0015615 A1
(43) Pub. Date: Jan. 15, 2009

(54) Liquid ejection control apparatus, liquid ejection control method and liquid ejection apparatus

(75) Inventor: Toru Miyamoto, Shiojiri-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 12/218,160

(22) Filed: Jul. 11, 2008

(30) Foreign Application Priority Data
Jul. 11, 2007 (JP) 2007-181821

(51) Int. Cl. B41J 29/38

(52) U.S. Cl. 347/14

(57) ABSTRACT

A liquid ejection control apparatus which controls a liquid ejection mechanism having a plurality of nozzle groups made up of a plurality of nozzles, comprising: a correction data acquisition unit which acquires correction data for each nozzle group; an image data separation unit which inputs image data comprising a plurality of pixels and separates the image data into respective split image data, each comprising pixels which are to be formed for liquid ejection by the respective nozzle groups; a split image data correction unit which corrects the respective split image data, on the basis of the correction data for the nozzle groups to which the split image data respectively correspond; and an ejection execution control unit which executes liquid ejection by driving the respective corresponding nozzle groups, on the basis of the corrected split image data.

The entire disclosure of Japanese Patent Application No. 2007-181821, filed Jul. 11, 2007, is expressly incorporated by reference herein.

### BACKGROUND

1. Technical Field

The present invention relates to a liquid ejection control apparatus, a liquid ejection control method and a liquid ejection apparatus.

2. Related Art

There are printers which carry out printing by forming a plurality of nozzles for ejecting ink, in which the nozzle rows for ejecting inks of respective colors are arranged respectively in a multiplexed fashion (a plurality of rows are provided). In a printer of this kind, it is possible to use selectively, for each color, nozzles of one nozzle row (called “main nozzle row” where appropriate), and nozzles of another nozzle row (called “back-up nozzle row” where appropriate). More specifically, when printing one image, either only the main (or back-up) nozzle rows are used, or the nozzles of the main nozzle rows and the nozzles of the back-up nozzle rows are used selectively for printing, at a prescribed usage ratio.

In the respective nozzles, there may be fluctuation in the ink ejection volume and/or fluctuation in the ink ejection direction (these fluctuations are referred to jointly as fluctuation in the ink ejection characteristics). Fluctuation in the ink ejection characteristics is a cause of density non-uniformities at the positions corresponding to the respective nozzles, in the print result. In order to suppress the occurrence of density non-uniformities of this kind, in International Patent No. WO2005/042255, for each nozzle, a correction value corresponding to the fluctuation in the ink ejection characteristics of the nozzle is acquired in advance on the basis of the print results of a prescribed test pattern, and during print processing, the respective pixels of the image data representing the image to be printed are corrected by means of the correction values relating to the nozzles corresponding to the respective pixels.

As described above, in a printer having multiplexed nozzle rows, main nozzle rows and back-up nozzle rows may be used in combination when printing one image. Here, there are various modes for determining the selective use of the nozzle rows, (namely, the nozzles of which type of nozzle rows are to be used at which locations in the image), for example, with a view to dealing with heat generation in the nozzles, avoiding the use of defective nozzles, and the like. Furthermore, in order to obtain good print results, it is necessary to subject the image data to correction for suppressing the density non-uniformities described above. However, the degree of correction applied to the respective pixels of the image data varies depending on the mode of selective use of the nozzle rows. Therefore, in order to obtain good print results at all times, using a printer having nozzle rows arranged in multiple layers, the volume of data required for correction becomes very large, and there is a problem in that the system for performing correction becomes highly complicated.

### SUMMARY

An advantage of some aspects of the present invention is to provide a liquid ejection control apparatus, a liquid ejection control method and a liquid ejection apparatus, whereby good liquid ejection results can be obtained at all times, by executing correction suited to the mode of selective use of a plurality of groups of nozzles, by means of simple processing.

The liquid ejection control apparatus according to the invention controls a liquid ejection mechanism having a plurality of nozzle groups made up of a plurality of nozzles for ejecting liquid. A correction data acquisition unit acquires correction data for each nozzle group, in order to correct density created by each nozzle group. Here, the acquisition of correction data includes: a process of inputting correction data from an external apparatus, a process of reading out correction data previously stored on a storage medium provided in the liquid ejection control apparatus, or processing for generating correction data, and the like. An image data separation unit inputs image data comprising a plurality of pixels and separates the image data into respective split image data, each comprising pixels which are to be formed for liquid ejection by the respective nozzle groups. A split image data correction unit corrects the split image data on the basis of the correction data of the nozzle groups to which the split image data respectively correspond. An ejection execution control unit executes liquid ejection by driving the nozzle groups to which the respective split image data correspond, on the basis of the corrected split image data.

In this way, according to the invention, the image data is divided into a plurality of pixel groups (split image data) in accordance with the different nozzle groups which are used for liquid ejection. The split image data are corrected on the basis of correction data for correcting the density created by the nozzle group to which the respective split image data correspond. Therefore, split images in which density non-uniformities are suppressed are output respectively by the nozzle groups, and as a result, it is possible to obtain a good output result which is free of density non-uniformities in the overall image which is formed by combining the respective split images.

In another example of the invention, the correction data acquisition unit acquires, as correction data for each nozzle group, correction values relating to the respective nozzles, which constitute the nozzle group, for correcting density deviation caused by fluctuation in the liquid ejection performance of each nozzle. Thereupon, the split image data correction unit corrects the graduated tone values of the pixels in the split image data, by using the correction values of the nozzles corresponding to the pixels. By means of this composition, it is possible to obtain good output results in which density non-uniformities caused by fluctuations in the liquid ejection performance between different nozzles are suppressed.

On the other hand, there are cases where, rather than the respective nozzles in a nozzle group each having different liquid ejection performance, a unit of a certain number of numbers may all tend to have distinctive liquid ejection performance. Therefore, in a further composition of the present invention, the correction data acquisition unit acquires, as correction data for each nozzle group, correction values relating to respective small nozzle groups each formed in units of the prescribed number of nozzles within the nozzle group, for correcting density deviation caused by fluctuation in the liquid ejection performance of each of the small nozzle groups; and the split image data correction unit corrects the graduated tone values of the pixels in the split image data, by using the correction values of the small nozzle groups to which the respective pixels correspond. According to this composition, compared to a case where correction is made by using correction values for each nozzle, only a small volume of correction data has to be acquired, and a good output result can be obtained in which density non-uniformities caused by fluctuations in the liquid ejection characteristics of the respective nozzle groups are suppressed.

In one example of separating the input image data, the image data separation unit acquires a separation mask which masks pixels at a prescribed ratio in the image data by means of a prescribed masking pattern, takes the pixels which have been masked by the separation mask, of the pixels of the image data, as the split image data corresponding to one nozzle group, and takes the pixels which have not been masked by the separation mask, of the pixels of the image data, as the split image data corresponding to another nozzle group. According to this composition, it is possible to separate the image data into respective split image data corresponding to the respective nozzle groups, easily, by simply superimposing a separation mask over the image data. If the number of nozzle groups is greater than two, for example, then the image data can be separated by using a further separation mask on the group of pixels which are not masked by applying a first separation mask.

Moreover, the liquid ejection control apparatus has a plurality of types of separation masks having mutually different masking patterns, and the image data separation unit selects the separation mask to be used on the basis of the state of the liquid ejection mechanism, or an instruction from an external source. Here, having mutually different masking patterns does not only mean cases where the ratio of masked pixels is different, but also includes cases where the ratio of masked pixels is the same but the positions of the masked pixels are different. According to this composition, it is possible to determine which pixels are to be ejected by which nozzle group, in accordance with the state of the liquid ejection mechanism, or the wishes of the user, or the like.

In one example, the image data separation unit may acquire the temperature of the nozzle groups, and select a separation mask in accordance with this temperature. Increase in the nozzle temperature is a case of problems in liquid ejection. Therefore, for example, if one of the nozzle groups is at a high temperature, a separation mask is selected which has a masking pattern whereby the number of pixels of the split image data corresponding to that one nozzle group is made smaller than hitherto, and the number of pixels of the split image data corresponding to the other nozzle group is made greater than hitherto.

In another example, the image data separation unit acquires the ejection defect information of the nozzle groups, and selects a separation mask on the basis of this ejection defection information. In this case, for example, if information indicating an ejection defect is acquired for one nozzle group, then a separation mask is selected which has a masking pattern whereby the number of pixels of the split image data corresponding to the other nozzle group is made greater than hitherto, or alternatively, a separation mask is selected which has a masking pattern whereby all of the pixels of the input image data are set as split image data corresponding to the other nozzle group.

Thus far, the technical concepts of the invention have been described in relation to a liquid ejection control apparatus, but these technical concepts may also be conceived as inventions relating to a method or a program product. In other words, it is also possible to conceive a liquid ejection control method comprising respective processes which correspond to the respective units provided in the liquid ejection control apparatus described above, or a program product which causes a computer to execute functions corresponding to these respective units.

Moreover, as an invention of product which displays similar actions and effects to the liquid ejection control apparatus described above, it is possible to conceive a liquid ejection apparatus having a plurality of nozzle groups made up of a plurality of nozzles for ejecting liquid; comprising: a correction data acquisition unit which acquires correction data for each nozzle group, in order to correct the density created by each nozzle group; an image data separation unit which inputs image data comprising a plurality of pixels and separates the image data into respective split image data, each comprising pixels which are to be formed for liquid ejection by the respective nozzle groups; an split image data correction unit which corrects the respective split image data, on the basis of the correction data for the nozzle groups to which the split image data respectively correspond; and an ejection execution unit which executes liquid ejection by controlling the driving of the respective nozzle groups to which the split image data correspond, on the basis of the corrected split image data.

### BRIEF DESCRIPTION OF THE DRAWINGS

FIG. 1 shows one example of a diagram showing the general composition of an apparatus relating to an embodiment of the invention;

FIG. 2 is a diagram showing one example of a print head unit;

FIG. 3 is a diagram showing one example of a print head unit;

FIG. 4 is one example of a flowchart showing the contents of a correction data generation process;

FIG. 5 is a diagram showing one example of a test pattern;

FIG. 6 is a diagram showing one example of the measurement results of a test pattern;

FIG. 7 is a diagram showing one example of correction data;

FIG. 8 is one example of a flowchart showing the contents of a print control process;

FIG. 9 is a diagram showing one example of separation mask;

FIG. 10 is a diagram showing one example of separation mask;

FIG. 11 is a diagram showing one example of separation mask;

FIG. 12 is one example of a flowchart showing the details of a split image data correction process;

FIG. 13 is a diagram showing one example of corrective function;

FIG. 14 is a diagram showing one example of mask determination table;

FIG. 15 is a diagram showing one example of the aspect of temperature change in respective multiplexed nozzle rows;

FIG. 16 is a diagram showing one example of a print head unit; and

FIG. 17 is a diagram showing one example of a print head unit.

### DESCRIPTION OF EXEMPLARY EMBODIMENTS

Embodiments of the invention are described below according to the following sequence.

1. General composition of apparatus

2. Acquisition of correction data

3. Liquid ejection control processing

4. Selection of separation mask

5. Modification examples

6. Summary

1. General Composition of Apparatus

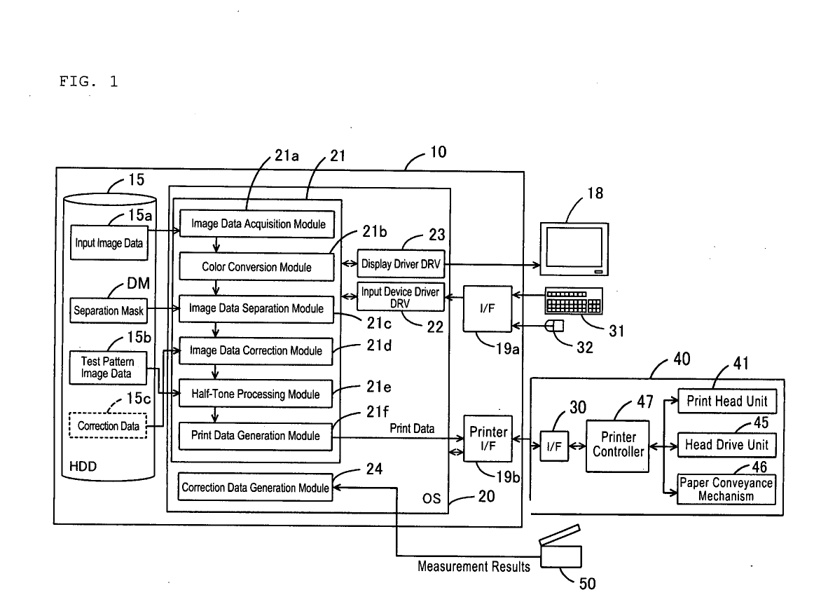

FIG. 1 shows the general composition of a computer, and the like, which relates to the present embodiment. The computer 10 comprises a CPU (not shown) which forms a kernel for calculation processing, a ROM forming a storage medium, a RAM, and the like, and it executes a prescribed program while using peripheral devices, such as the HDD 15. A printer 40 which forms a printing apparatus is connected to the computer 10 via a printer interface 19b (for example, a serial I/F). Apart from this, the computer 10 is also connected via an interface 19a to operating input devices, such as a keyboard 31, a mouse 32, or the like, and furthermore, it is also connected to a display monitor 18 via a video board, which is not shown. The computer 10 is the main control apparatus for the printer 40, and it forms a liquid ejection control apparatus. Furthermore, the computer 10, the printer 40, and other apparatuses may be referred to jointly as a single liquid ejection control apparatus.

In the computer 10, a printer driver 21, an input apparatus driver 22 and a display driver 23 are incorporated into the OS 20. The display driver 23 is a driver which controls the display of the image to be printed, and the prescribed user interface (UI) screen, and the like, on the display monitor 18. The input apparatus driver 22 is a driver which accepts prescribed input operations by receiving code signals from a keyboard 31 or mouse 32, via the interface 19a.

The printer driver 21 can execute the printing of the printer 40 (printing being one type of liquid ejection) by carrying out prescribed image processing in respect of the image which has been instructed for printing by the application program (not shown). In order to implement print control, the printer driver 21 comprises: an image data acquisition module 21a, a color conversion module 21b, an image data separation module 21c, an image data correction module 21d, a half-tone processing module 21e, and a print data generation module 21f. Furthermore, the OS 20 also incorporates a correction data generation module 24 for generating correction data, which is described hereinafter.

The printer driver 21 is driven when a print instruction as described above is issued, and the printer driver 21 sends data to the display driver 23, where the aforementioned User Interface (UI) screen is displayed. When the user has input the required print conditions, as appropriate, via the UI screen, by operating the keyboard 31, mouse 32, or the like, the respective modules of the printer driver 21 are started up, and the respective modules carry out processing for each pixel of the input image data (image data which represents the image to be printed) 15a, thereby creating print data (raster data). The raster data thus created is output to the printer 40 via the printer interface 19b, and the printer 40 executes printing on the basis of this raster data. The functions of the respective modules are described hereinafter.

The printer 40 comprises a print head unit 41 which ejects inks (one type of liquid) of a plurality of colors onto printing paper. In one example of the present embodiment, the printer 40 ejects inks of the respective colors of C (cyan), M (magenta), Y (yellow) and K (black). The printer 40 can also create a plurality of colors by combining the inks of the respective colors, and thereby forms a color image on the printing paper. The number of inks and type of ink used in the printer 40 are not limited to those described above, and it is possible to use inks of various types, such as Lc (light cyan), Lm (light magenta), Lk (gray), LLk (light gray), and so on.

The printer 40 comprises a communications interface 30 which connects with the printer interface 19b, and two-way communications between the computer 10 and the printer 40 are conducted via the printer interface 19b and the communications interface 30. The communications interface 30 can receive separate raster data for each ink type which has been sent by the computer 10. Furthermore, the printer 40 comprises a CPU (not shown), and storage media including a ROM, RAM, and the like, and it executes a prescribed program (printer controller 47). The printer controller 47 is a program which executes various controls for print processing, and it controls various mechanisms inside the printer 40, such as the print head unit (one type of liquid ejection mechanism) 41, the head drive unit 45, the paper supply mechanism 46, and the like.

The print head unit 41 comprises a plurality of nozzles for ejecting inks of respective colors, and is mounted with ink cartridges for supplying inks of the respective colors to the nozzles corresponding to those colors. In the present embodiment, the printer 40 is taken to be a so-called line head printer. Therefore, a plurality of nozzles are arranged densely in a direction perpendicular to the paper feed direction of the print paper in the print head unit 41. The printer 40 may also use a serial type of print head. The printer controller 47 outputs application voltage data corresponding to the raster data described above, to the head drive unit 45. From the application voltage data, the head drive unit 45 generates an application voltage pattern (drive signals) for the piezoelectric elements which are disposed so as to correspond respectively to the nozzles of the print head unit 41, and it ejects ink droplets (dots) of the inks of respective colors, from the print head unit 41. However, for the method of ejecting dots, apart from a method which uses the deformation of piezoelectric elements by means of a drive signal as described above, it is also possible to use various other methods, such as a thermal ejection method. The paper feed mechanism 46 is controlled by the printer controller 47 so as to convey printing paper in a prescribed paper feed direction, by means of paper conveyance rollers, which are not illustrated.

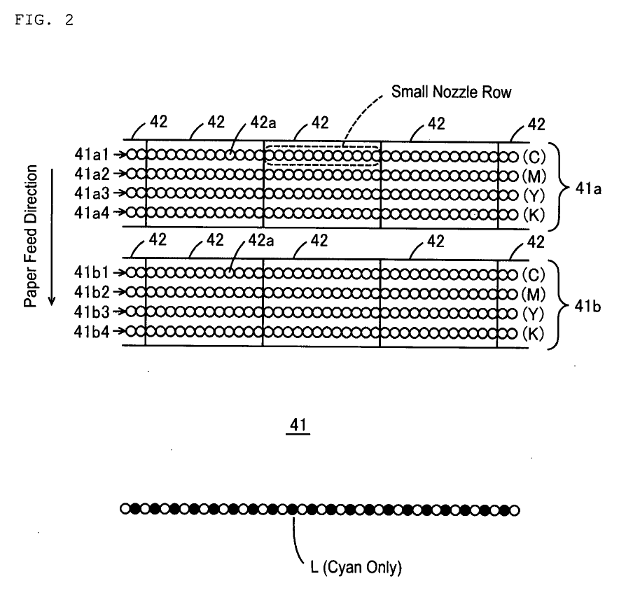

FIG. 2 shows an example of one portion of a surface in which nozzles are arranged in the print head unit 41. As shown in FIG. 2, the print head unit 41 is constituted by the first head unit 41a and the a second head unit 41b. The first head unit 41a is formed by aligning a plurality of print heads 42 through a length corresponding substantially to the width of the printing paper, following the direction perpendicular to the paper feed direction, and in a similar fashion, the second head unit 41b is also formed by aligning a plurality of print heads 42 through a length corresponding substantially to the width of the printing paper, following the aforementioned perpendicular direction. Each of the print heads 42 is formed with rows of nozzles 42a of a number corresponding to the number of colors of ink used by the printer 40 (in the case of the present embodiment, four colors: C, M, Y, K). Therefore, in the first head unit 41a, nozzle rows 41a1, 41a2, 41a3, 41a4 of a length corresponding substantially to the width of the printing paper are formed, corresponding respectively to the different colors of ink, and similarly, in the second head unit 41b, nozzle rows 41b1, 41b2, 41b3, 41b4 of a length corresponding substantially to the width of the printing paper are formed, corresponding respectively to the different colors of ink. The number of nozzles 42a in each of the nozzle rows (nozzle row 41a1, 41a2, 41a3, 41a4, 41b1, 41b2, 41b3, 41b4) is N.

In this way, in the print head unit 41, the first head unit 41a and the second head unit 41b each comprise one row of nozzles for ejecting each color of ink, C, M, Y and K. In this sense, the print head unit 41 can be regarded as having multiplexed nozzle rows for ejecting each of the respective ink colors. Furthermore, the print head unit 41 also has a plurality of nozzle groups, in the sense that for each of the ink colors, a plurality of nozzle rows (which are one type of nozzle group) for ejecting each color are provided (for example, nozzle row 41al and nozzle row 41bl are provided for ink C).

In the print head unit 41, the plurality of nozzle rows corresponding to the same ink color can be used selectively, in units of one dot. Here, a hypothetical case is described, in which, as shown in the lower part of FIG. 2, a raster line L is printed by a certain ink color (for example, C) only, following a direction which is perpendicular to the paper feed direction. In this case, in the print head unit 41, all of the N dots which constitute the raster line L could be printed by the nozzles 42a of nozzle row 41a1, and all of the dots could also be printed by the nozzles 42a of the nozzle row 41b1. Furthermore, it is also possible to switch the nozzle 42a used between the nozzle row 41al and the nozzle row 41b1, for each dot. For example, as shown in FIG. 2, the dots indicated by the white circles in raster line L can be printed by the nozzles 42a of the nozzle row 41a1, and the dots indicated by the black circles in raster line L can be printed by the nozzles 42a of the nozzle row 41b1. The switching of nozzles 42a between the nozzle rows in this way is carried out by means of the printer controller 47 selecting the output destination of the drive signal from the head drive unit 45 (namely, by selecting the piezoelectric element of the nozzle 42a that is to receive the signal).

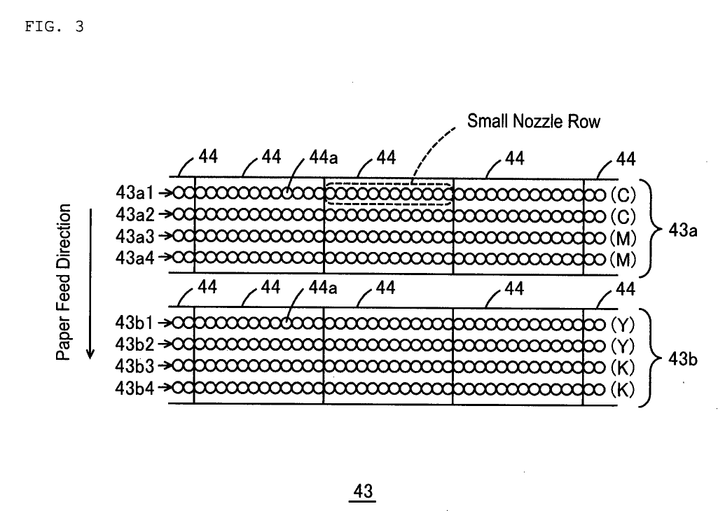

FIG. 3 shows a further example of the structure of a print head unit. The print head unit 43 shown in FIG. 3 comprises a first head unit 43a and a second head unit 43b, and both of the head units 43a and 43b are respectively formed by aligning a plurality of print heads 44 through a length corresponding substantially to the width of the printing paper, in the direction perpendicular to the paper feed direction. Furthermore, each of the print heads 44 is formed with a number of rows of nozzles 44a corresponding to the number of colors of ink used by the printer 40. However, in the print head unit 43, the nozzle rows 43a1, 43a2, 43a3, 43a4 of the first head unit 43a do not each correspond respectively to different ink colors, but rather, a composition is adopted in which two adjacent rows correspond to the same ink color. For example, the nozzle rows 43a1 and 43a2 are used for ejecting C ink, and the nozzle rows 43a3 and 43a4 are used for ejecting M ink. Similarly, the nozzle rows 43b1, 43b2, 43b3, 43b4 of the second head unit 43b do not each correspond respectively to different ink colors, but rather, a composition is adopted in which two adjacent rows correspond to the same ink color. For example, the nozzle rows 43b1 and 43b2 are used for ejecting Y ink and the nozzle rows 43b3 and 43b4 are used for ejecting K ink.

Naturally, the structure of the print head unit used in the printer 40 is not limited to the modes shown in FIG. 2 or FIG. 3 described above, and it is possible to adopt any composition provided that a plurality of groups of nozzles for ejecting the respective ink colors are provided, for each color (in other words, provided that the nozzles are multiplexed).

The description give below relates to an example where the print head unit 41 is used as a print head unit.

2. Acquisition of Correction Data

In the present embodiment, in the process of converting the input image data 15a into print data, correctional processing is carried out in accordance with the ink (liquid) ejection characteristics of the respective nozzles 42a of the print head unit 41. This correctional processing is executed by using previously generated correction data. Firstly, the process of generating correction data is described below. This correction data is generated respectively for each nozzle row.

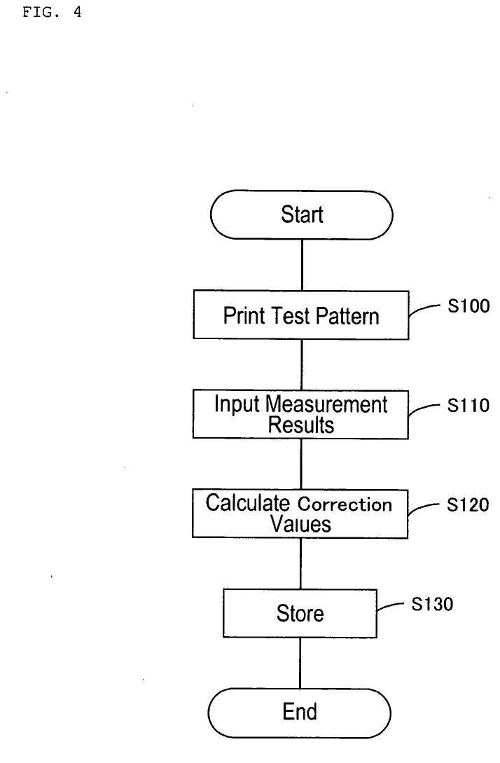

FIG. 4 shows the contents of the correction data generation processing which is executed by the computer 10. Here, the description is given with respect to an example of a method of generating correction data for one nozzle row 41a1, of the plurality of nozzle rows 41a1, 41b1 which correspond to the C ink in the print head unit 41.

At step S (used below as an abbreviation for “step”) 100, the computer 10 controls the printer 40 so as to print a prescribed test pattern with C ink using only the nozzles 42a of the nozzle row 41a1, onto the printing paper. More specifically, firstly, the printer driver 21 acquires test pattern image data 15b which represents a test pattern, from the HDD 15, or the like. The test pattern image data 15b is prepared in advance for each color of ink used by the printer 40. The test pattern image data 15b is data which defines each image pixel as a tonal value (for example, 256 tones, from 0 to 255) of a particular color, and the whole image represents a prescribed density pattern based on using this one ink color.

More specifically, the test pattern image data 15b according to the present embodiment represents an image in which respective density regions (for example, regions having a dot coverage ratio per prescribed unit surface area of 10%, 30%, 50%, 70% and 90%, respectively), which correspond to a graduated tone values of a plurality of steps (for example, graduated tone values p1, p2, p3, p4, p5), are arranged in sequence in the feed direction of the printing paper. The printer driver 21 transfers the test pattern image data 15b relating to C ink, to the half-tone processing module 21e. The half-tone processing module 21e executes a so-called half-toning process (binarization process) on the test pattern image data 15b, thereby generating half-tone data which specifies dot ejection (on) or dot non-ejection (off) for each pixel. The half-tone processing module 21e is able to execute half-toning by means of various methods, such as error diffusion, dithering, or the like.

Thereupon, the print data generation module 21f receives the half-tone data and generates sequentially rearranged C raster data for use by the printer 40, which it outputs successively to the printer 40. Identification information for identifying the nozzle row to be used to eject the ink for each dot is appended to the raster data, and by this means, the printer 40 (printer controller 47) carries out printing while selecting the nozzle to which the drive signal is to be applied, accordingly. As a result, a prescribed test pattern is printed on the printing paper, by ejection of C ink from the nozzles 42a of the nozzle row 41a1.

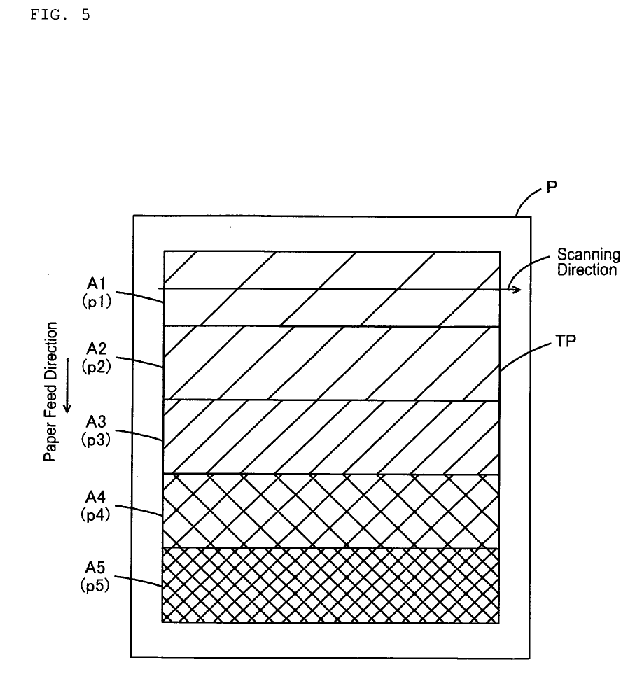

FIG. 5 shows one example of a test pattern which has been printed as described above. As shown in FIG. 5, a test pattern TP having a density which changes in step fashion in the paper feed direction is printed onto printing paper P. In FIG. 5, the respective regions of different density in the test pattern TP are indicated as density regions A1 to A5. Furthermore, there is also a correspondence between the density regions A1 to A5, and the graduated tone values p1 to p5 which are represented by the density regions A1 to A5 in the test pattern image data 15b.

Next, at S110, the computer 10 inputs measurement results for the test pattern TP as obtained by a prescribed measurement device. As shown in FIG. 1, a density measurement device 50 (for example, a scanner) is connected to the computer 10. By scanning the density measurement device 50 over the test pattern TP, it is possible to measure optically the density of prescribed positions on the test pattern TP, and the corresponding measurement results are gathered in the form of luminosity information L having 256 tonal values, for example.

In S110 described above, the computer 10 controls the density measurement device 50 so as to respectively measure the density of the density regions A1 to A5 in the test pattern TP. In this case, for each density region, measurement is performed in a prescribed line following the breadthways direction of the test pattern TP (a direction perpendicular to the paper feed direction), at a pitch corresponding to the pitch of the nozzles 42a in the nozzle row 41a1, and hence measurement results for (N) nozzles are input.

At S120, the computer 10 calculates correction values for the respective nozzles 42a in the nozzle row (nozzle row 41a1) for which correction data is being generated, on the basis of the measurement results for the test pattern TP input at S110. This calculation processing is carried out by the correction data generation module 24.

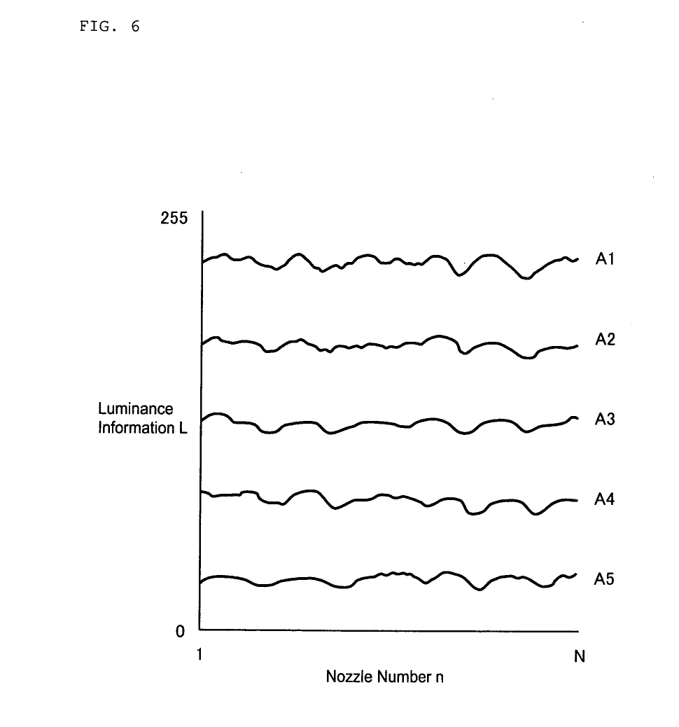

FIG. 6 shows one example of the measurement results for the test pattern TP. In FIG. 6, the vertical axis indicates the measurement results (luminosity information L) for the respective density regions A1 to A5, and the horizontal axis indicates the number n (1≦n≦N) of the nozzle 42a in the nozzle row 41a1 used to print the test pattern TP. As described above, in measuring the test pattern TP, scanning is performed in parallel to the direction of the nozzle rows, and therefore the respective measurement results at a total of N points situated at substantially equidistant intervals on the measurement path indicate the respective print results of N individual nozzles 42a. Ideally, the measurement results for the density regions A1 to A5 are as uniform as possible in the horizontal direction, but due to fluctuations in the ink ejection performance of the nozzles 42a which make up the nozzle row 41a1, some variation occurs, as shown in FIG. 6.

For each density region A1 to A5, the correction data generation module 24 calculates a corrective value Hn corresponding to each nozzle number n, on the basis of the differential between a prescribed target density and the measurement result corresponding to each nozzle number n. For example, the correction data generation module 24 determines the average value Lav of the measurement results corresponding to the respective nozzle numbers 1 to N, as obtained by the measurement of density region A1, and this average value Lav is taken to be the target density for the density region A1. Thereupon, the correction data generation module 24 calculates the differential ΔL=|Lav−Ln| between this target density Lav and the measurement result Ln of one nozzle number n obtained by the measurement of density region A1, and then sets a correction value h for that nozzle number n by dividing the differential ΔL by the average value Lav. In other words,

h=ΔL/Lav (1)

Here, if Ln>Lav, then this means that the density of the print result for the aforementioned one nozzle number n is brighter (less dense) than the target value, and therefore correction is carried out in order that the graduated tone value of the pixels that are to be ejected by the nozzle 42a corresponding to that nozzle number n becomes greater than the original graduated tone value, by a factor of h. Consequently, it is possible to make the density printed by the nozzle 42a corresponding to the nozzle number n close to the target density. Therefore, in this case, the correction value Hn corresponding to the nozzle number n, which is derived from the measurement results for the density region A1 will be (100+h)/100.

On the other hand, if Ln<Lav, then this means that the density of the print result for the aforementioned one nozzle number n is darker (more dense) than the target value, and therefore correction is carried out in order that the graduated tone value of the pixels that are to be ejected by the nozzle 42a corresponding to that nozzle number n becomes smaller than the original graduated tone value, by a factor of h. Consequently, it is possible to make the density of the line printed by the nozzle 42a corresponding to the nozzle number n close to the target density. Therefore, in this case, the correction value Hn corresponding to the nozzle number n, which is derived from the measurement results for the density region A1 will be (100−h)/100.

This calculation of correction values is carried out respectively for each nozzle number n, and for each density region A1 to A5.

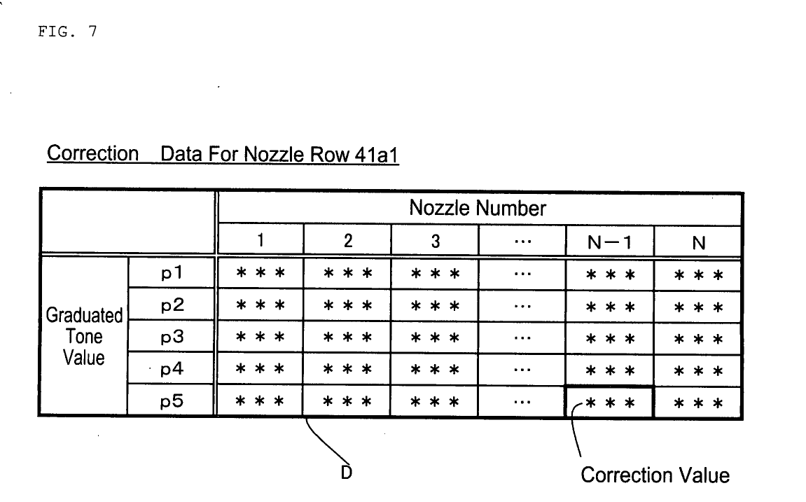

FIG. 7 shows correction data D obtained by the processing in S120. As FIG. 7 shows, the correction data D consists of correction values for each nozzle number and for each graduated tone value (p1 to p5) of the test pattern image data 15b, as obtained from the measurement results of the test pattern TP which has been printed by ejecting ink of one color (C) using one nozzle row (nozzle row 41a1) only.

Of course, the number of graduated tone values (number of density regions) in the test pattern TP does not have to be five steps, as shown in FIG. 5, and this number may be varied as appropriate.

At S130, the computer 10 (correction data generation module 24) outputs the correction data generated as described above, to the printer 40, via the printer interface 19b, and the data is stored on a prescribed storage medium provided in the printer 40 (for example, a storage medium provided in the print head unit 41). The computer 10 sequentially carries out similar processing to that shown in FIG. 4, by specifying each individual nozzle row of the print head unit 41, in turn. As a result, correction data for each graduated tone value of the test pattern image data 15b is stored on the storage medium of the printer 40 in respect of the nozzles of each of the nozzle rows 41a1, 41a2, 41a3, 41a4, 41b1, 41b2, 41b3, 41b4.

3. Liquid Ejection Control Processing

Next, the liquid ejection control process (print control process) which is associated with the correction processing using the correction data described above will be explained.

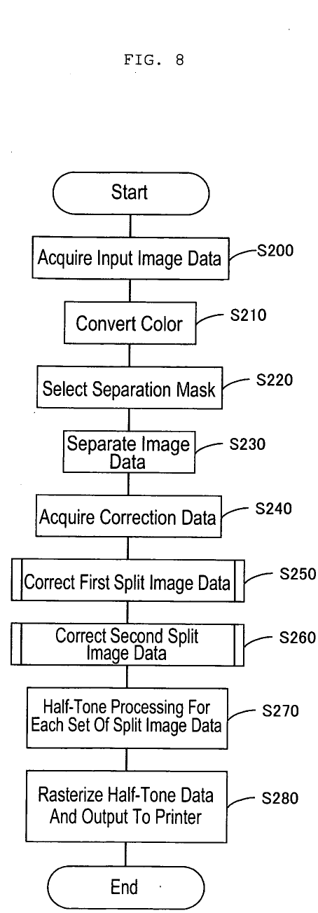

FIG. 8 is a flowchart showing the contents of print control processing which is executed by the computer 10. This processing is executed principally by the printer driver 21.

At S200, the image data acquisition module 21a acquires the input image data 15a from the HDD 15, or the like. The input image data 15a is dot matrix data which specifies the colors of the respective pixels, by representing tonal values of the respective color elements R (red), G (green), B (blue), and it uses a colorimetric system which complies with the sRGB standards. Naturally, it is also possible to use various other types of data, such as JPEG image data which uses a YCbCr calorimetric system, image data which uses a CMYK colorimetric system, or the like. Furthermore, the image data acquisition module 21a may also input image data from an image input apparatus, such as a digital still camera (not illustrated), or the like, which is connected to the computer 10, rather than the HDD 15.

In S200 described above, according to requirements, prescribed resolution conversion processing suited to the output resolution of the printer 40 is carried out on the input image data 15a.

At S210, the color conversion module 21b converts the colorimetric system of the input image data 15a to the colorimetric system of the ink colors used by the printer 40. More specifically, the color conversion module 21b refers to a color conversion look-up table (LUT) (not illustrated), which has been stored previously in the HDD 15, or the like, and converts the RGB data of the respective pixels of the input image data 15a into respective graduated tone values for C, M, Y and K (CMYK data). The color conversion LUT is a table which records universal associations between prescribed reference points (RGB data) in the sRGB color space and CMYK data. The color conversion module 21b is thereby able to convert any RGB data into CMYK data, by referring to the color conversion LUT and carrying out a suitable interpolation calculation, or the like. In the present embodiment, the respective values for CMYK before and after color conversion are represented in terms of 256 tonal values.

As stated previously, the print head unit 41 has multiplexed nozzle rows for ejecting each color of ink, respectively. Therefore, when carrying out printing on the basis of the input image data 15a, it is possible to combine the use of both of the nozzle rows which are in a multiplexed relationship. In the present embodiment, image data representing an image to be printed is separated into image data (first split image data) which is to be formed by ink ejected from one of the nozzle rows of the two nozzle rows which are in a multiplexed relationship (nozzle row 41a1, 41a2, 41a3, 41a4) and image data (second split image data) which is to be formed by ink ejected from the other nozzle row (nozzle row 41b1, 41b2, 41b3, 41b4).

In S220, the image data separation module 21c selects a separation mask DM for separating the image data into a plurality of split image data, from amongst a plurality of types of separation masks DM, according to the prescribed standards. The respective separation masks DM are stored in a prescribed storage region of the HDD 15, or the like, and the image data separation module 21c acquires a prescribed separation mask DM from this storage region, as and when necessary.

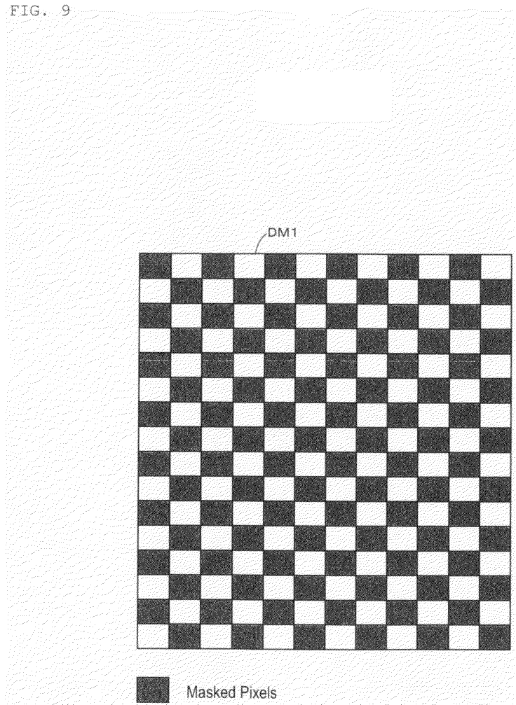

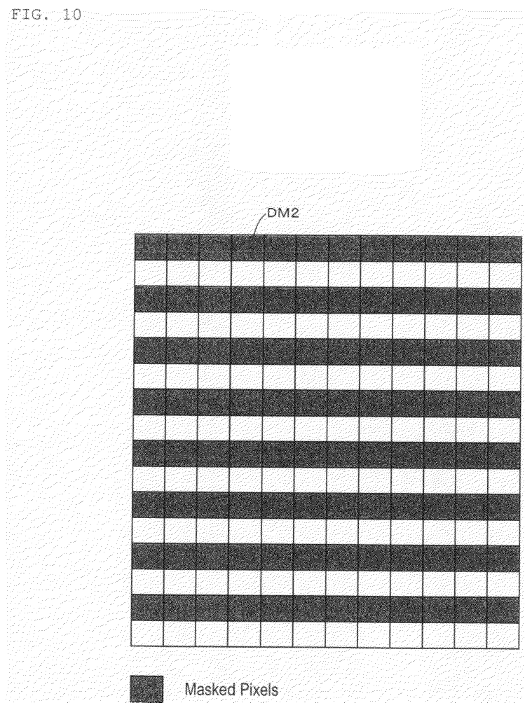

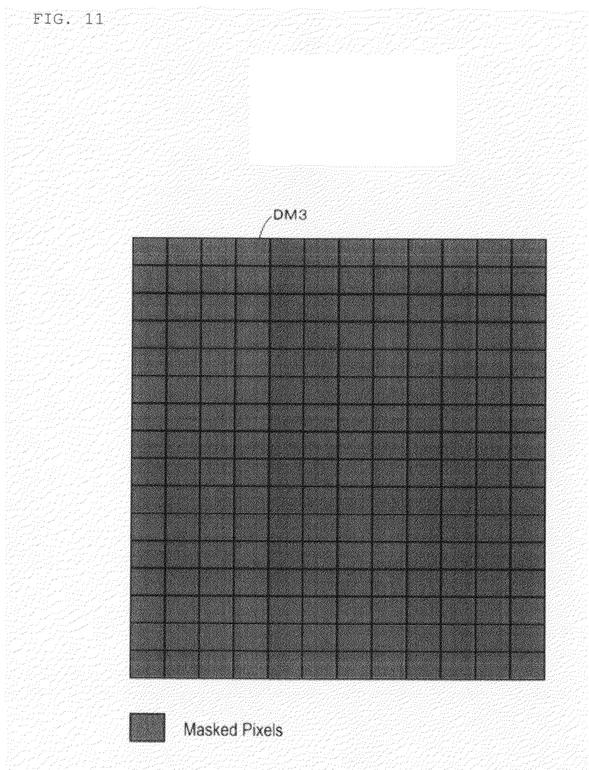

FIGS. 9, 10 and 11 show examples of separation masks DM. These separation masks DM respectively have a prescribed masking pattern, which masks (covers) a prescribed ratio of the pixels in the image data when superimposed over the image data under processing. The separation mask DM1 in FIG. 9 comprises a checkerboard masking pattern, and when this is superimposed over the image data, the pixels in the image data are masked in a checkerboard pattern. The separation mask DM2 in FIG. 10 comprises an alternating line masking pattern, and when this is superimposed over the image data, the pixels in every other line are masked. The separation masks DM1, DM2 both have a masking ratio of 50%. The separation mask DM3 shown in FIG. 11 has a masking pattern with a masking ratio of 100%, and when superimposed over the image data, it masks all of the pixels. The separation masks DM are not limited to those shown in FIG. 9, FIG. 10 and FIG. 11, and apart from these, it is also possible to use masks having various masking ratios, such as a pattern which masks 75% of all of the pixels in the image data, or a pattern which masks 25% of all of the pixels in the image data.

The standards for selecting the separation mask DM are described hereinafter.

At S230, the image data separation module 21c applies the separation mask DM selected at S220, to the image data which has already undergone the color conversion processing described above, and thereby separates the image data into first split image data and second split image data. More specifically, the pixels which are masked when the separation mask DM is superimposed on the image data are taken to be the first split image data, and the pixels which are not masked when the separation mask DM is superimposed on the image data are taken to be the second split image data. Consequently, if the separation mask DM2 is used, for example, then the odd-numbered pixel rows from the top edge of the image will form the first split image data and the even-numbered pixel rows will form the second split image data. In this sense, the image data separation module 21c performs the function of an image data separation unit.

At S240, the image data correction module 21d acquires the correction data described above, from the printer 40, via the printer interface 19b. More specifically, the image data correction module 21d outputs a correction data request signal to the printer 40, and upon receiving this request signal, the printer 40 reads out the correction data stored in the storage medium and output this data to the computer 10. Upon receiving the correction data, the image data correction module 21d stores the correction data as correction data 15c in a prescribed storage region of the HDD 15, or the like.

At S250, the image data correction module 21d performs correction with respect to the first split image data, on the basis of the correction data 15c which has been determined respectively for the nozzle rows 41a1, 41a2, 41a3 and 41a4.

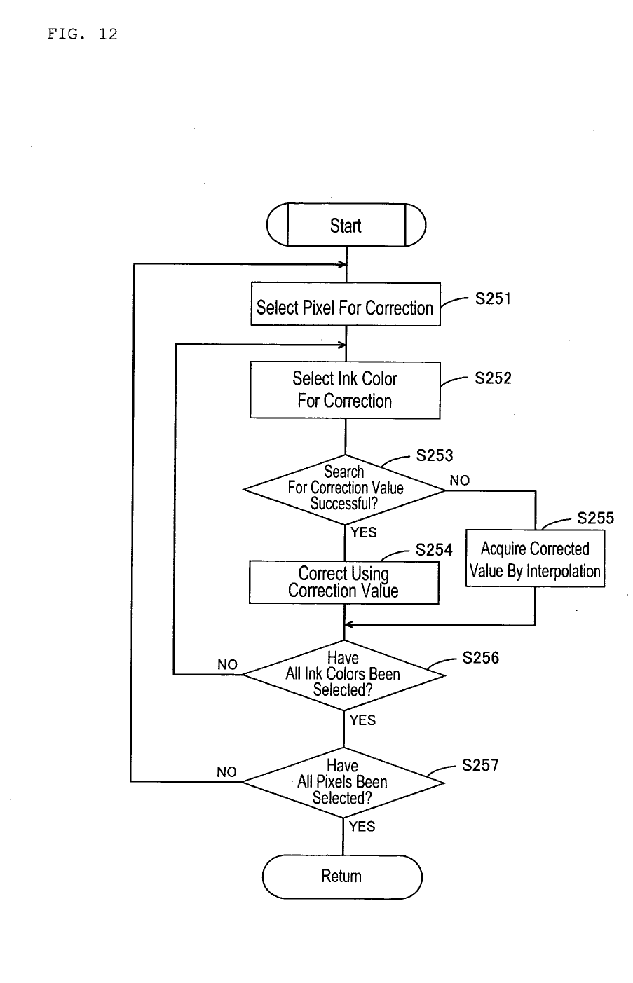

FIG. 12 is a flowchart showing details of the processing in step S250.

In S251, the image data correction module 21d selects one pixel for correction, according to a prescribed sequence, from the pixels which make up the first split image data. For example, if the first split image data is formed by the odd-numbered pixel rows of the image data after color conversion processing, then the left-most pixel of the uppermost row is selected first at the pixel for correction.

At S252, the image data correction module 21d selects the graduated tone value relating to one ink color (for example, the graduated tone value of C) as the graduated tone value for correction, of the graduated tone values of the respective ink colors CMYK in the pixel which is currently under correction.

At S253, the image data correction module 21d searches the correction data 15c to find a correction value corresponding to the graduated tone value of the ink color selected at S252. More specifically, it reads out the correction data relating to the nozzle row (nozzle row 41a1) corresponding to the ink color selected at S252, from the correction data 15c which corresponds respectively to the nozzle rows 41a1, 41a2, 41a3, 41a4. The image data correction module 21d then identifies whether or not there is a correction value corresponding to the graduated tone value selected for correction as described above, amongst the respective correction values relating to the nozzle number which corresponds to the position of the pixel selected at S251 in the correction data which has been read out.

Here, this pixel position means the position of the column in the image data, after resolution conversion processing and before separation; these positions are allocated in sequence, 1, 2, 3, and so on, to each column, from the left-hand edge to the right-hand edge of the image. In other words, the position of the pixel coincides with the nozzle number of the nozzle 42a which is used to print that pixel. As described previously, correction values are only stored for any one nozzle 42a in relation to graduated tone values of a plurality of steps (p1 to p5) which correspond to the respective density regions (A1 to A5) of the test pattern TP. If the graduated tone value selected above as the object for correction matches the graduated tone value of one of the plurality of steps (p1 to p5), then the correction value stored in association with the matching graduated tone value is acquired, and the procedure then advances to S254 (search successful).

At S254, the image data correction module 21d multiplies the graduated tone value which is the object of correction by the correction value acquired by the search in S253, thereby correcting the graduated tone value under correction.

On the other hand, if the search for the correction value in S253 is not successful, then the procedure advances to S255, and a corrected value for the graduated tone value which is the object of correction is calculated by interpolation.

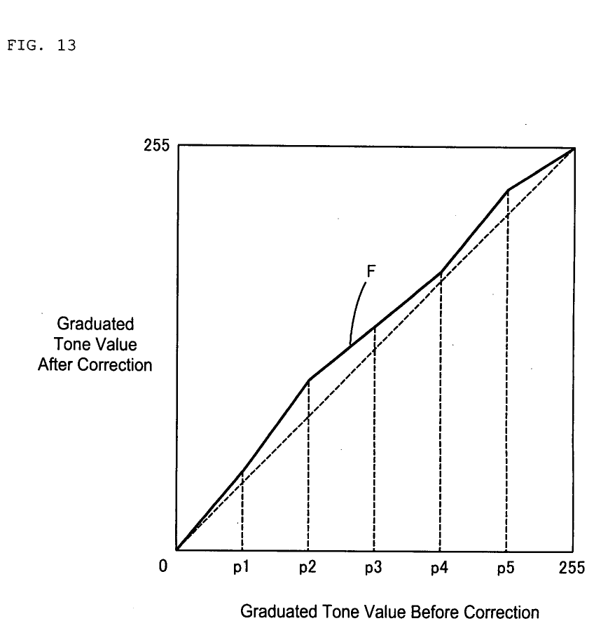

FIG. 13 shows one example of a function used for this interpolation process. In FIG. 13, the vertical axis represents the graduated tone value after correction, and the horizontal axis represents the graduated tone value before correction. On this two-dimensional system, a corrective function F is depicted which corrects the print density caused by fluctuations in the ink ejection performance of one nozzle 42a. More specifically, the image data correction module 21d generates a corrective function F as shown in FIG. 13 by linking together, by interpolation, the respective correction results for the graduated tone values of the plurality of steps (p1 to p5) obtained on the basis of the respective correction values corresponding to the graduated tone values of the plurality of steps (p1 to p5) relating to the nozzle 42a corresponding to the pixel, and the ink color relating to the graduated tone value which is the object of correction. The corrected values of the graduated tone value which is the object of correction are derived on the basis of the corrective function F thus generated. The corrective function F can be used commonly for the graduated tone values relating to the ink color selected at S252, in respect of all of the pixels which have a common position (column position) to the pixel selected at S251, of the respective pixels in the first split image data.

At S256, the image data correction module 21d judges whether or not the graduated tone values relating to all of the ink colors CMYK have been selected in relation to the pixel selected in the previous execution of step S251, and if there are still ink colors which are pending (which have not yet been selected), then the procedure returns to S252, a pending ink color is selected, and the processing from S253 onwards is repeated. On the other hand, if it is judged that all of the graduated tone values relating to all of the ink colors CMYK have been selected in respect of the pixel selected in the previous execution of S251, then the procedure advances to S257.

At S257, the image data correction module 21d judges whether or not all of the pixels which constitute the first split image data have been selected as a pixel for correction, and if there are pixels which are pending (which have not yet been selected), then the procedure returns to S251, a pending pixel is selected as an object for correction, and the processing from S252 onwards is repeated. On the other hand, if it is judged that all of the pixels constituting the first split image data have been selected for correction, then the flowchart shown in FIG. 12 is terminated.

The explanation now returns to FIG. 8.

At S260, the image data correction module 21d performs correction with respect to the second split image data, on the basis of the correction data 15c which has been determined respectively for the nozzle rows 41b1, 41b2, 41b3 and 41b4. The details of step S260 are omitted from this description, since it is similar to step S250, except for the fact that the objects for correction are the pixels of the second split image data, and the correction values relating to the nozzle rows 41b1, 41b2, 41b3, 41b4 are used for correction.

By executing the processing in steps S240 to S260 in this way, the image data correction module 21d can be regarded as performing the function of a correction data acquisition unit and a split image data correction unit. Furthermore, considering the fact that the correction data generation module 24 previously generates correction data, then the correction data generation module 24 also corresponds to the correction data acquisition unit.

The sequence of processing in the steps S210 to S260 does not have to adhere strictly to the sequence shown in FIG. 8. For example, it is sufficient that the processing for selecting the separation mask DM should be carried out before the image data separation process, and that the acquisition of correction data from the printer 40 should be carried out before the correction process for the respective sets of split image data. The sequence of the first split image data correction process and the second split image data correction process may be the reverse of that described above, or these processes may be carried out in parallel with each other.

At S270, the half-tone processing module 21e carries out half-tone processing respectively in relation to the first split image data after correction and the second split image data after correction. As a result, first half-tone data which specifies dot on/off for each ink color in each pixel of the first split image data, and second half-tone data which specifies dot on/off for each ink color in each pixel of the second split image data, is obtained.

In S280, the print data generation module 21f receives the first half-tone data, and successively converts this first-half tone data to raster data for driving the nozzles 42a of the nozzle rows 41a1, 41a2, 41a3, 41a4, and outputs same to the printer 40. Furthermore, the print data generation module 21f successively converts the second half-tone data into raster data for driving the nozzles 42a of the respective nozzle rows 41b1, 41b2, 41b3, 41b4, and outputs same to the printer 40. Consequently, printing of the pixels of the first split image data is carried out by ejecting ink from the nozzles 42a of the nozzle rows 41a1, 41a2, 41a3, 41a4, and printing of the pixels of the second split image data is carried out by ejecting ink from the nozzles 42a of the nozzle rows 41b1, 41b2, 41b3, 41b4, thereby completing the printing of one image.

In the image thus printed, any position which has been printed by a nozzle 42a of the nozzle rows 41a1, 41a2, 41a3, 41a4 will have an ink volume that has been corrected by the correction value relating the nozzle 42a of the nozzle rows 41a1, 41a2, 41a3, 41a4 which corresponds to that position, and any position which has been printed by a nozzle 42a of the nozzle rows 41b1, 41b2, 41b3, 41b4 will an have ink volume that has been corrected by the correction value relating to the nozzle 42a of the nozzle rows 41b1, 41b2, 41b3, 41b4 which corresponds to that position. Therefore, in the overall image, satisfactory image quality is obtained and density non-uniformities are suppressed. Since the computer 10 is able to execute the processing in steps S270 and S280, then it can be considered that a portion of its functions correspond to the ejection execution control unit. Alternatively, the term “ejection execution control unit” can be used to include the functions of the computer 10 which execute step S270 and S280, and the printer controller 47 in the printer 40, and the head drive unit 45, and the like.

4. Selection of Separation Mask

Next, the judgment standards for selecting the separation mask DM in step S220 will be described. One object of multiplexing the nozzle rows respectively for each ink color as in the present embodiment is to deal with the issue of heat generation in the nozzles. In other words, if the same nozzle is used continuously, then that nozzle retains heat and problems are more liable to occur in nozzles which have become very hot. Therefore, the image data separation module 21c selects a separation mask DM as described below, for example, by considering heat countermeasures.

The image data separation module 21c acquires the temperature of the first head unit 41a in step S220. In this case, a temperature sensor which measures the temperature at a prescribed position of the nozzle rows in the first head unit 41a is provided in the printer 40. In response to a request from the computer 10, the printer 40 sends the measurement result T for the temperature of the first head unit 41a at the time of receiving the request, to the computer 10. The image data separation module 21c selects a separation mask DM in accordance with the measurement result T.

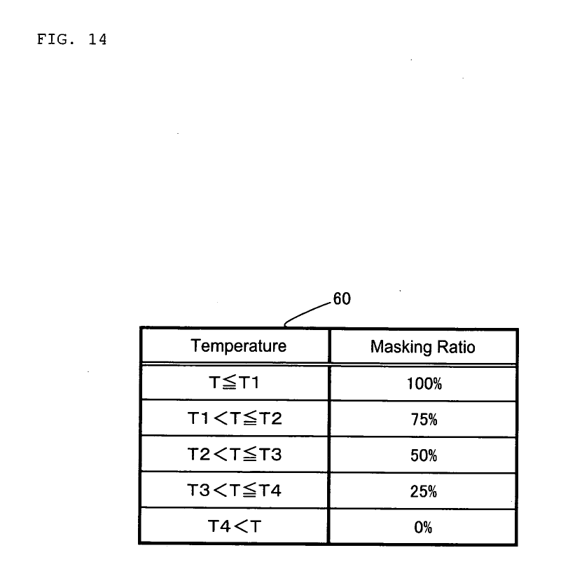

FIG. 14 is a mask determination table 60 showing one example of the relationship between the temperature of the first head unit 41a and the masking ratio of the separation mask DM. In this table 60, the masking ratio of the separation mask DM is specified for respective temperature intervals in the temperature range which the measurement result T is expected to occupy. In FIG. 14, a masking ratio of 100% is set if T≦T1, a masking ratio of 75% is set if T1<T≦T2, a masking ratio of 50% is set if T2<T≦T3, a masking ratio of 25% is set if T3<T≦T4, and a masking ratio of 0% is set if T4<T (where, T1<T2<T3<T4). The image data separation module 21c refers to the table 60 and selects a separation mask DM having a masking ratio corresponding to the measurement result T.

By adopting this composition, the higher the temperature of the nozzle row of the first head unit 41a, the smaller the number of pixels in the first split image data (and the greater the number of pixels in the second split image data), and hence the usage rate of the nozzles in the first head unit 41a is reduced (and the usage rate of the nozzles in the second head unit 41b is increased). On the other hand, the lower the temperature of the nozzle row of the first head unit 41a, the greater the number of pixels in the first split image data (and the lower the number of pixels in the second split image data), and hence the usage rate of the nozzles in the first head unit 41a is increased (and the usage rate of the nozzles in the second head unit 41b is reduced). In other words, of the nozzle rows which are in a multiplexed relationship, the nozzle row which does not have a raised temperature is used more frequently, and therefore it is possible to avoid problems, such as abnormal increase in the temperature of one of the nozzle rows due to exclusive use of one of the multiplexed nozzle rows only.

In the foregoing description, a separation mask DM (the masking ratio of the separation mask DM) is selected on the basis of the temperature of the first head unit 41a, but it is also possible to select the separation mask DM in accordance with the relative difference between the temperature of the first head unit 41a and the second head unit 41b. In this case, the image data separation module 21c acquires the temperature of the first head unit 41a in step S220 and the temperature of the second head unit 41b. In other words, the printer 40 comprises, in addition to the temperature sensor described above, a temperature sensor which measures the temperature at a prescribed position of the nozzle rows of the second head unit 41b, and hence the measurement result Ta for the temperature of the first head unit 41a and the measurement result Tb for the temperature of the second head unit 41b are sent to the computer 10 in response to a request from the computer 10. The image data separation module 21c determines the differential T between the measurement results Ta and Tb, as T=Ta−Tb. The masking ratio is then determined according to which of the number intervals T1 to T4 the differential T corresponds to (in accordance with the masking determination table 60 described above), and a separation mask DM having the specified masking ratio is selected.

However, if the masking ratio is determined on the basis of the differential T, then the temperatures T1 to T4 in the mask determination table 60 in FIG. 14 are re-read as threshold values T1 to T4, and these threshold values T1 to T4 are set so that T1<T2<T3<T4, T1 and T2 are prescribed negative values, and T3 and T4 are prescribed positive values. According to this composition, if the first head unit 41a is tending to have a higher temperature than the second head unit 41b, then the number of pixels in the first split image data is reduced accordingly, and hence the usage rate of the nozzles in the first head unit 41a is reduced. On the other hand, if the second head unit 41b is tending to have a higher temperature than the first head unit 41a, then the number of pixels in the first split image data is increased accordingly, and hence the usage rate of the nozzles in the first head unit 41a is increased. In other words, since the nozzle row having the relatively lower temperature is used more frequently, of the related nozzle rows which are multiplexed, then it is possible to restrict increase in the temperature of the respective nozzle rows, in an appropriate fashion.

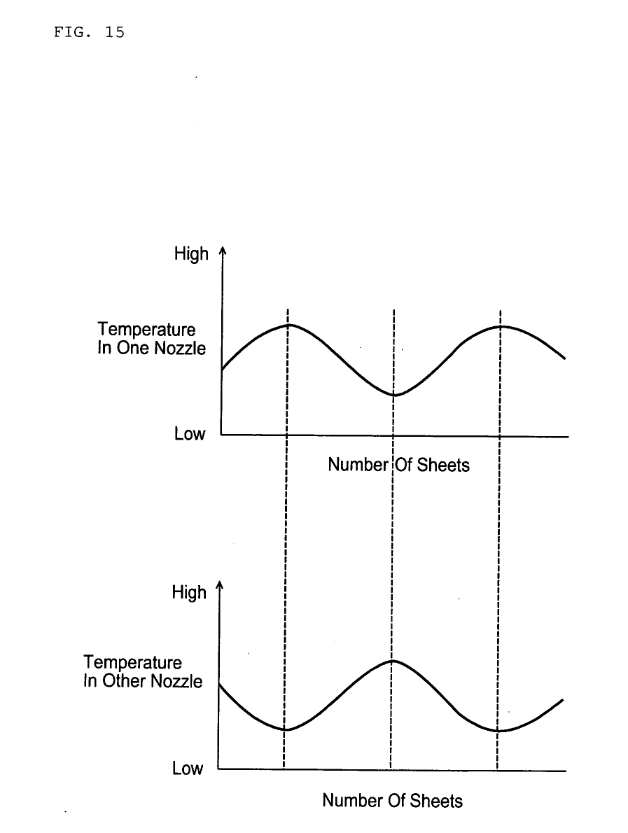

The method of selection a separation mask DM which takes account of heat countermeasures is not limited to that described above. For example, it is possible to set the image data separation module 21c so as to select a separation mask DM in such a manner that the temperature of one nozzle row of the multiplexed nozzle rows and the temperature of the other nozzle row of the multiplexed nozzle rows change in a substantially opposite phase relationship, as shown in FIG. 15. For example, the image data separation module 21c switches the separation mask DM used, in such a manner that the masking ratio of the separation mask DM changes in sequence, from 50%→75%→100%→75%→50%→25%→0%→25%→50%. The mask may be switched once per printed image sheet, or once every certain number of sheets. By switching the separation mask DM in this way, the one nozzle row and the other nozzle row of the multiplexed nozzle rows have directly opposite rise and fall timings in respect of their nozzle usage rate, and therefore their temperature change curves which show repeated temperature rise and temperature fall have a substantially opposite phase relationship. Therefore, it is possible to avoid situations where both the one nozzle row and the other nozzle row become very hot, and therefore the product lifespan of both nozzle rows can be extended suitably.

A further object of multiplexing the nozzle rows corresponding to the respective ink colors is to avoid the use of nozzles which are suffering an ejection failure. In other words, by multiplexing the nozzle rows corresponding to the respective ink colors, then even when a nozzle in one nozzle row is in a defective state, normal printing is achieved by using the other nozzle row. For example, the image data separation module 21c acquires ejection defect information for the first head unit 41a in step S220. In this case, it is supposed that the printer 40 comprises an ink ejection determination sensor which determines the presence or absence of ink ejection in (all or a portion) of the nozzles 42a of the first head unit 41a. The printer 40 sends the past determination results of the ink ejection determination sensor, to the computer 10, on the basis of an ejection defect information request from the computer 10. The image data separation module 21c also inputs this determination information, as ejection defect information, and analyzes the information; for example, if a prescribed number or more of the nozzles 42a in the first head unit 41a are in a defective state, then it is decided that the nozzle rows of the first head unit 41a are in a defective state.

In this case, the image data separation module 21c selects a separation mask DM having a masking ratio of 0% (or a separation mask DM having a masking ratio close to 0%). Therefore, the number of pixels in the first split image data becomes zero or a number close to zero, and all or almost all of the pixels which represent the image for printing are printed by the nozzle rows of the second head unit 41b. Consequently, it is possible to avoid problems where printing is carried out by nozzle rows of the first head unit 41a where a large number of nozzles 42a are in a defective state. The printer 40 may also be provided with an ink ejection determination sensor which determines the presence or absence of ink ejection at (all or a portion of) the respective nozzles 42a of the second head unit 41b, and the image data separation module 21c may select the separation mask DM in such a manner that a larger number of pixels are provided by the head unit which has the smaller number of nozzles 42a suffering an ejection defect, of the first head unit 41a and the second head unit 41b.

Moreover, the image data separation module 21c selects a separation mask DM in accordance with an external instruction. In other words, if the user has issued an instruction for selecting a separation mask DM, via the user interface screen described above, or the like, then the separation mask DM corresponding to this selection instruction is read out from the storage region, such as the HDD 15, and this mask is used for image data separation processing. By adopting this composition, it is possible to use nozzle rows which are provided in a multiplexed relationship, in accordance with a use ratio desired by the user.

5. Modification Examples

Various other modes relating to the present invention can be envisaged, apart from those described above.

The correction values may also be generated in units of a prescribed number of nozzles in one nozzle row, rather than for each individual nozzle 42a.

As shown in FIG. 2 and FIG. 3, the nozzle rows are formed by joining together a plurality of print heads. Therefore, for example, it is possible to divide the nozzles 42a (nozzles 44a) which constitute one nozzle row, into units based on the print head 42 (print head 44), and to generate common correction values for one sequence of nozzles formed in a common print head 42 (print head 44), (namely, the small nozzle group enclosed by the broken line in FIGS. 2 and 3; hereinafter called “small nozzle row”).

In other words, since the nozzles which make up one small nozzle row are formed in the same print head, then it is considered that the difference between their respective ink ejection characteristics will be relatively small, whereas between different small nozzle rows, it is considered that the difference in the ink ejection characteristics will tend to be greater.

In this case, at step S120, the correction data generation module 24 generates correction values for each small nozzle row, by finding the average, in the small nozzle row unit, of the correction values calculated for each nozzle. As a result of this, correction data consisting of correction values for each small nozzle row and for each graduated tone value of the test pattern image data is generated, in relation to each nozzle row (nozzle rows 41a1, 41a2, 41a3, 41a4, 41b1, 41b2, 41b3, 41b4, or the nozzle rows 43a1, 43a2, 43a3, 43a4, 43b1, 43b2, 43b3, 43b4). By adopting this composition, it is only necessary to store a small volume of correction data. Furthermore, when correcting the pixels of the split image data, it is possible to correct a number of pixels which are grouped together to a certain extent, on the basis of common correction data, and therefore the burden involved in the correction processing is reduced.

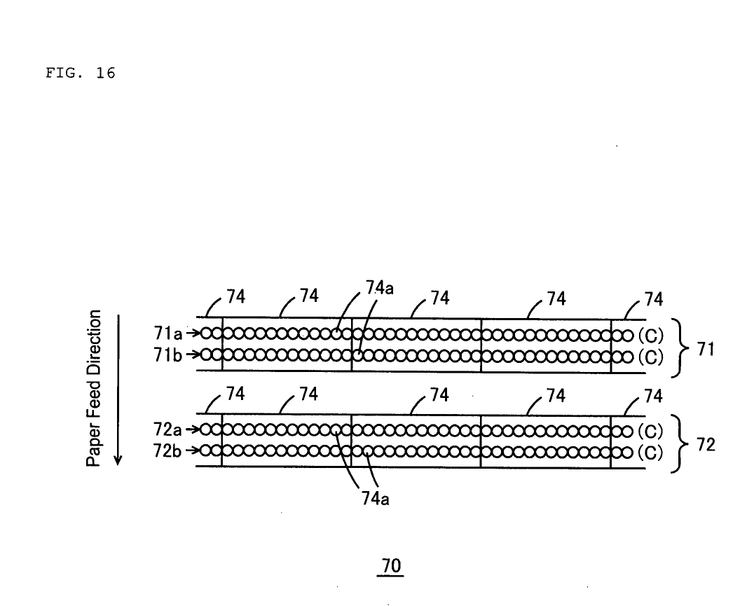

Moreover, the correction values may also be generated in units comprising a number of nozzles which is greater than the small nozzle rows described above. For example, a print head unit 70 such as that shown in FIG. 16 can be imagined. The print head unit 70 comprises a first head unit 71 and a second head unit 72, and the respective head units 71 and 72 are composed by arranging a plurality of print heads 74 respectively in a direction that is perpendicular to the paper feed direction. The first head unit 71 and the second head unit 72 are composed respectively by a plurality of nozzle rows (in FIG. 16, by two nozzle rows). The nozzle rows 71a and 71b of the first head unit 71 and the nozzle rows 72a and 72b of the second head unit 72 are all nozzle rows which correspond to the same color of ink (for example, C ink), and in printing the respective pixels, it is possible to use either a nozzle 74a belonging to the nozzle group consisting of nozzle rows 71a and 71b, or a nozzle 74a belonging to the nozzle group consisting of nozzle rows 72a and 72b, selectively, in units of one pixel. Naturally, a plurality of nozzle groups consisting of a plurality of nozzle rows can also be provided for the other ink colors, in such a manner that a plurality of nozzle groups are used selectively, for each color of ink. Therefore, in the example shown in FIG. 16, the nozzle groups corresponding to the respective ink colors are each multiplexed.

In this composition, it is possible to divide the nozzles 74a which make up one nozzle group, into units of one print head 74, and to generate a common correction value for each of the nozzles 74a (small nozzle groups) which are formed in the same print head 74. In other words, it is considered that the nozzles 74a formed in the same print head 74 will essentially have little difference in respect of their ink ejection characteristics, whereas it is thought that there will be a large difference in the tendency of ink ejection characteristics, between different print heads 74. In this case, at step S120, the correction data generation module 24 carries out processing for generating a correction value for each print head 74, by finding the average, for each print head 74 unit, of the correction values determined for each nozzle of the nozzle group (for example, the nozzle rows 71a and 71b of the first head unit 71), or the correction values determined for each nozzle of one nozzle row (nozzle row 71a or nozzle row 71b) in the nozzle group which represents the nozzle group. Consequently, correction data consisting of correction values for each print head 74 and for each graduated tone value of the test pattern image data is generated in respect of each of the nozzle groups. By adopting a composition of this kind, it is only necessary to store a small volume of correction data. Furthermore, when correcting the pixels of the split image data, it is possible to correct a number of pixels which are grouped together to a certain extent, on the basis of common correction data, and therefore the burden involved in the correction processing is reduced.

In the foregoing description, multiplexing of nozzle groups was achieved by providing two nozzle groups corresponding to one ink color, but it is also possible to multiplex the nozzle groups by providing three or more groups.

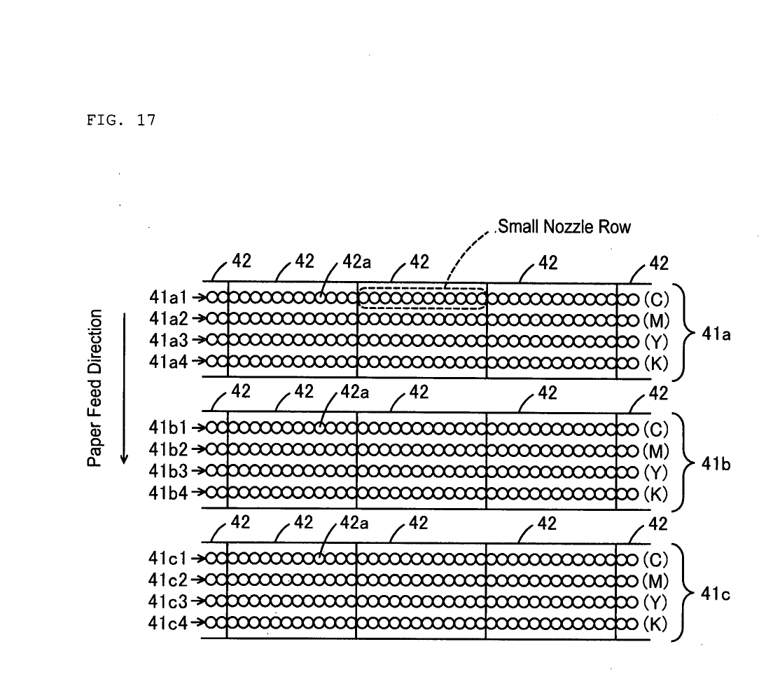

For example, as shown in FIG. 17, it is also possible to adopt a structure for the print head unit in which a third head unit 41c is added to the first head unit 41a and the second head unit 41b in FIG. 2. In this composition, the third head unit 41c is also formed by arranging a plurality of print heads 42 through a length corresponding substantially to the width of the printing paper, in a direction that is perpendicular to the paper feed direction. Furthermore, the third head unit 41c is formed with nozzle rows 41c1, 41c2, 41c3, 41c4 of a length corresponding substantially to the width of the printing paper, which relate to the number of colors of ink used by the printer 40.

If the printer 40 uses a print head unit in which the nozzle rows relating to each color of ink are multiplexed respectively in a three rows each, then it is necessary to separate the image data representing the image to be printed, into three sets of split image data. In other words, the image data separation module 21c uses a separation mask DM to separate the image data representing the image to be printed, into first split image data, second split image data, and image data (third split image data) that is to be formed for ink ejection by the nozzle rows 41c1, 41c2, 41c3, 41c4. There are various possible modes of the separation masks DM for splitting the image data into three sets in this way. For example, two separation masks DM whose masking patterns are not mutually overlapping are prepared, and the pixels which are masked by one separation mask DM are taken as the first split image data, the pixels which are masked by the other separation mask DM are taken as the second split image data, and the remaining pixels which are not masked by either of the separation masks are taken as the third split image data. Alternatively, a separation mask DM is prepared which has a masking pattern that classifies the pixels into three groups when superimposed on the image to be printed, and the image data is separated into three sets of split image data in one process, by applying this separation mask DM to the image data of the image to be printed.

When using a print head unit as shown in FIG. 17, the computer 10 prints a test pattern for each of the nozzle rows in each of the first head unit 41a, the second head unit 41b and the third head unit 41c, and it generates correction data for each nozzle row on the basis of the respective print results.

Moreover, the process of separating the image data may also be carried out independently in respect of each ink color. In other words, upon receiving the image data which has been subjected to color conversion processing by the color conversion module 21b, the image data separation module 21c selects a separation mask DM for each ink color, and applies the separation mask DM selected for each ink color, to the dot matrix of image data corresponding to each ink color. Consequently, it is possible to alter the mode of selective use of the multiplexed nozzles, between each ink color, in such a manner that when printing a particular pixel, a certain ink color of that pixel is printed by a nozzle 42a of a nozzle row belonging to the first head unit 41a, but when printing another ink color for that pixel, a nozzle 42a of a nozzle row belonging to the second head unit 41b is used. This composition is useful from the viewpoint of avoiding dealing with the generation of head, and avoiding the use of defective nozzles.

For example, in the printer 40, if it is possible to measure the temperature in each nozzle row which corresponds to a different ink color, then it can be reliably expected that different measurement results will be obtained for each nozzle row. Therefore, the image data separation module 21c refers to the mask determination table 60 in FIG. 14, for example, and selects a separation mask DM for each ink color, on the basis of the temperature measurement result for the corresponding nozzle row. Consequently, it is possible to make selective use of the multiplexed nozzle rows in a manner which suits the temperature situation of the nozzle rows of the respective ink colors, and therefore an optimal countermeasure against heat can be achieved. Furthermore, when analyzing the ejection defect information, the image data separation module 21c may also count the number of nozzles which are in a defective state, in each nozzle row, and select a separation mask DM for each of the ink colors corresponding to the respective nozzle rows, on the basis of the count results for each nozzle row. If this selection process is adopted, then, it is possible to achieve fine control whereby, for example, of the nozzle rows 41a1, 41a2, 41a3, 41a4 belonging to the first head unit 41a, only those nozzle rows which have a large number of nozzles 42a in a defective state are switched to use nozzle rows 41b1, 41b2, 41b3, 41b4 in the second head unit 41b.

6. Summary

In this way, according to the present embodiment, a structure is adopted in which the nozzle groups (nozzle rows, and the like) corresponding to the respective ink colors are multiplexed in the printer 40, and the computer 10 generates, for each nozzle group, correction data for correcting non-uniformities in the print results which are caused by fluctuation in the ink ejection characteristics of the nozzles. In carrying out print control processing on the basis of the image data which represents the image to be printed, the computer 10 applies a separation mask DM selected according to prescribed standards, to the image data, thereby separating the image data into image data that is to be printed by one of the multiplexed nozzle groups (first split image data), and image data that is to be printed by the other of the multiplexed nozzle groups (second split image data), the first split image data is corrected by using the correction data relating to the one nozzle group, the second split image data is corrected using the correction data relating to the other nozzle group, the driving of the one nozzle group is controlled on the basis of the first split image data after correction, and the driving of the other nozzle group is controlled on the basis of the second split image data after correction, thereby creating a print of the image to be printed.

According to the composition described above, since an image having suppressed density non-uniformity is printed by each of the respective nozzle groups, then in the completed overall image which is obtained by combining the respective images printed by each nozzle group, there is no density non-uniformity and extremely good image quality is achieved. Furthermore, the computer 10 only has to perform interpolation of the correction data for each nozzle group, followed by binarization and rasterization, for each of the sets of split image data obtained by separation using the separation mask DM, and therefore it is possible to correct the image data readily, using a small volume of correction data, in a manner which suits various modes of selective use of the multiplexed nozzle groups in the printer 40.

It is also possible for all or a portion of the respective processes performed by the computer 10 above, and in particular the processes shown in FIGS. 4 and 8, to be carried out in the printer 40. In this case, the printer 40 becomes one example of a liquid ejection apparatus.

In the foregoing description, the composition of a liquid ejection control apparatus and liquid ejection apparatus was applied principally to a printer 40 which is an inkjet recording apparatus, or to an apparatus comprising such as printer 40, but the scope of application of the above-described composition of a liquid ejection control apparatus and liquid ejection apparatus is not limited to this. For example, it may also be applied to a liquid ejection apparatus which ejects a liquid other than ink (including liquids in which particles of organic material are dispersed, or fluids such as gels), or which ejects a fluid other than liquid (for instance, a solid which can be ejected by being caused to flow in the form of a fluid). For example, this composition may be used in: a liquid ejection apparatus which ejects a material in the form of a liquid containing electrode material, coloring material, or the like, in dispersed or dissolved form, as used in the manufacture of liquid crystal displays, EL (electroluminescence) displays, or a surface emitting display; a liquid ejection apparatus which ejects biological organic material as used in biochip manufacture; or a liquid ejection apparatus which is used as a precision pipette device and ejects liquid to form samples. Other possible applications are: a liquid ejection apparatus which ejects lubricating oil in a pinpoint fashion onto high-precision machinery, such a watch or a camera; a liquid ejection apparatus which ejects a transparent resin liquid, such as ultraviolet-curable resin, onto a substrate, in order to form miniature hemispherical lenses (optical lenses) for use in optical communications elements, and the like; a liquid ejection spray apparatus which ejects etching liquid, such as an acid or alkali liquid, in order to etch a substrate, or the like; a fluid ejection apparatus which ejects a gel; or a powder ejection recording apparatus which ejects a solid, for example, a powder such a toner, or the like.

While the invention has been particularly shown and described with respect to preferred embodiments thereof, it should be understood by those skilled in the art that the foregoing and other changes in form and detail may be made therein without departing from the spirit and scope of the invention as defined in the appended claims.

What is claimed is:

1. A liquid ejection control apparatus which controls a liquid ejection mechanism having a plurality of nozzle groups made up of a plurality of nozzles for ejecting liquid; comprising:
a correction data acquisition unit which acquires correction data for each nozzle group, in order to correct density created by each nozzle group;
an image data separation unit which inputs image data comprising a plurality of pixels and separates the image data into respective split image data each comprising pixels which are to be formed for liquid ejection by the respective nozzle groups;
a split image data correction unit which corrects the respective split image data, on the basis of the correction data for the nozzle groups to which the split image data respectively correspond; and
an ejection execution control unit which executes liquid ejection by driving the respective nozzle groups to which the split image data correspond, on the basis of the corrected split image data.

2. The liquid ejection control apparatus according to claim 1, wherein
the correction data acquisition unit acquires, as correction data for each nozzle group, correction values relating to the respective nozzles, which constitute the nozzle group, for correcting density deviation caused by fluctuation in the liquid ejection performance of each of the nozzles; and
the split image data correction unit corrects graduated tone values of the pixels in the split image data by using the correction values for the nozzles which correspond to the respective pixels.

3. The liquid ejection control apparatus according to claim 1, wherein
the correction data acquisition unit acquires, as correction data for each nozzle group, correction values relating to respective small nozzle groups each formed in units of the prescribed number of nozzles within the nozzle group, for correcting density deviation caused by fluctuation in the liquid ejection performance of each of the small nozzle groups; and
the split image data correction unit corrects the graduated tone values of the pixels in the split image data by using the correction values for the small nozzle groups to which the respective pixels correspond.

4. The liquid ejection control apparatus according to claim 1, wherein the image data separation unit acquires a separation mask which masks the pixels at a prescribed ratio in the image data by a prescribed masking pattern, takes the pixels which have been masked by the separation mask, of the pixels of the image data, as the split image data corresponding to one nozzle group, and takes the pixels which have not been masked by the separation mask, of the pixels of the image data, as the split image data corresponding to another nozzle group.

5. The liquid ejection control apparatus according to claim 4, wherein a plurality of types of separation masks having different masking patterns are provided, and the image data separation unit selects a separation mask to be used on the basis of a state of the liquid ejection mechanism or an instruction from an external.

6. The liquid ejection control apparatus according to claim 5, wherein the image data separation unit acquires temperature of the nozzle groups and selects a separation mask in accordance with this temperature.

7. The liquid ejection control apparatus according to claim 5, wherein the image data separation unit acquires ejection defect information for the nozzle groups and selects a separation mask on the basis of this ejection defect information.

8. A liquid ejection control method for controlling a liquid ejection mechanism having a plurality of nozzle groups made up of a plurality of nozzles for ejecting liquid, the method comprising:
acquiring correction data for each nozzle group, in order to correct density created by each nozzle group;
inputting image data comprising a plurality of pixels and separating the image data into respective split image data each comprising pixels which are to be formed for liquid ejection by the respective nozzle groups;
correcting the respective split image data, on the basis of the correction data for the nozzle groups to which the split image data respectively correspond; and
executing liquid ejection by driving the respective nozzle groups to which the split image data correspond, on the basis of the corrected split image data.

9. A liquid ejection apparatus having a plurality of nozzle groups made up of a plurality of nozzles for ejecting liquid; comprising:
a correction data acquisition unit which acquires correction data for each nozzle group, in order to correct density created by each nozzle group;
an image data separation unit which inputs image data comprising a plurality of pixels and separates the image data into respective split image data, each comprising pixels which are to be formed for liquid ejection by the respective nozzle groups;
an split image data correction unit which corrects the respective split image data, on the basis of the correction. data for the nozzle groups to which the split image data respectively correspond; and
an ejection execution unit which executes liquid ejection by controlling driving of the respective nozzle groups to which the split image data correspond, on the basis of the corrected split image data.
